(19) United States
(12) Patent Application Publication
(10) Pub. No.: US 2012/0103290 A1
(43) Pub. Date: May 3, 2012

(54) Synergistic Combination of a Hindered Phenol and Nitrogen Containing Detergent for Biodiesel Fuel to Improve Oxidative Stability

(76) Inventors: Sarah J. Startin, Derbyshire (GB); David Hobson, Derbyshire (GB)

(21) Appl. No.: 12/530,627

(22) PCT Filed: Apr. 1, 2008
(86) PCT No.: PCT/US08/59012

§ 371 Date: Mar. 22, 2011

Related U.S. Application Data
(60) Provisional application No. 60/910,044, filed on Apr. 4, 2007.

(51) Int. Cl. F02B 51/00; C10L 1/18

(52) U.S. Cl. 123/1 A; 44/388

(57) ABSTRACT

The present invention provides a fuel composition comprising a C1-4 alkyl fatty acid ester, a nitrogen containing detergent, and a phenolic antioxidant. Additionally, the present invention provides for a method of supplying to an internal combustion engine (i) a C1-4 alkyl fatty acid ester; (ii) a fuel which is a liquid at room temperature other than (i); (iii) a nitrogen containing detergent; (iv) and a phenolic antioxidant.

### BACKGROUND OF THE INVENTION

The present invention relates to a fuel composition and the method for fueling an internal combustion engine, providing oxidative stability to biodiesel fuels.

The use of conventional or traditional diesel fuel is being scrutinized because of the negative impact diesel fuel has on the environment. In light of this, the use of fatty acid esters, particularly fatty acid methyl ester (FAME), commonly referred to as a biofuel or biodiesel has become more widespread in recent years. Biodiesel is a clean burning alternative fuel, produced from domestic, renewable resources. Biodiesel contains no petroleum, but it can be blended at any level with petroleum diesel to create a biodiesel blend. Biodiesel can be used in compression-ignition engines with little or no modifications to such engines. Biodiesel is simple to use, biodegradable, nontoxic, and essentially free of sulfur and aromatics. Biodiesel also produces fewer particulate matter, carbon monoxide, and sulfur dioxide emissions. Since biodiesel can be used in conventional diesel engines, the renewable fuel can directly replace petroleum products; reducing the country's dependence on imported oil. Additionally, biodiesel offers safety benefits over petroleum diesel because it is much less combustible, with a flash point significantly greater conventional petroleum diesel. Thus, it is safer to handle, store, and transport compared to conventional petroleum diesel. The benefits of biodiesel are abundant, however, the use of biodiesel in a compression-ignition engine has technical issues. These issues include: increased fuel injector deposits, which are believed to get worse as polyunsaturated content of bio-diesel increases, as a result of polymerization of unsaturated fatty esters; reduced thermal and oxidative storage stability (gum formation may lead to fuel filter plugging or premature fuel filter failure, as well as fuel system corrosion arising from the production of organic acids; poorer water separation compared to conventional diesel fuel, contributing to possible fuel filter plugging, fuel system corrosion and possible bacterial contamination and growth.

The present invention, therefore, solves the problems of associated with biodiesel fuels tendency to form engine deposits, corrosiveness, and a loss of fuel economy by providing a synergistic combination of hindered phenol and nitrogen containing detergent for biodiesel that prevent engine deposits by slowing the oxidation of the biodiesel.

### SUMMARY OF THE INVENTION

The present invention provides a fuel composition comprising:
a. C₁₋₄ alkyl fatty acid ester;
b. a nitrogen containing detergent; and
c. a phenolic antioxidant.

The present invention further provides a method for fueling an internal combustion engine, comprising:

A. supplying to an internal combustion engine:
i. C₁₋₄ alkyl fatty acid ester;
ii. a fuel which is a liquid at room temperature other than (i);
iii. a nitrogen containing detergent; and
iv. a phenolic antioxidant.

### DETAILED DESCRIPTION OF THE INVENTION

Various preferred features and embodiments will be described below by way of non-limiting illustration.

### FIELD OF THE INVENTION

The present invention involves a fuel composition that includes: C₁₋₄ alkyl fatty acid ester, a nitrogen containing detergent, and a phenolic antioxidant.

The invention further involves a method of operating an internal combustion engine comprising supplying to the internal combustion engine (i) a C1-4 lower alkyl fatty acid ester; (ii) a fuel which is a liquid at room temperature other than (i); (iii) a nitrogen containing detergent; and (iv) a phenolic antioxidant.

The fuel compositions and method of the present invention promote engine cleanliness and fuel economy, while controlling oxidation, which enables optimal engine operation.

C₁₋₄ Alkyl Fatty Acid Ester

C₁₋₄ alkyl fatty acid ester of the present invention, often referred to as biofuel or biodiesel, are made from fatty acids having from 14 to 24 carbon atoms and alcohols having from 1 to 4 carbon atoms. Typically, a relatively large portion of the fatty acids contains one, two or three double bonds. Examples of typical alkyl fatty acid esters of the aforementioned type include: rapeseed oil acid methyl ester and mixtures which can comprise rapeseed oil fatty acid methyl ester, sunflower oil fatty acid methyl ester and/or soya oil fatty acid methyl ester.

Examples of oils useful for the preparation of the fatty acid ester, which are derived from animal or vegetable material, include rapeseed oil, coriander oil, soya oil, cottonseed oil, sunflower oil, castor oil, olive oil, peanut oil, maize oil, almond oil, palmseed oil, coconut oil, mustardseed oil, bovine tallow, bone oil and fish oils. Further examples include oils which are derived from wheat, jute, sesame, shea tree nut, arachis oil and linseed oil. The fatty acid alkyl esters of the present invention can be derived from these oils by processes known from the prior art. Rapeseed oil, which is a mixture of fatty acids partially esterified with glycerol, is a commonly used oil to make the alkyl fatty acid ester, because it is obtainable in large amounts and is obtainable in a simple manner by extractive pressing of rapeseeds.

Useful alkyl fatty acid esters can include, for example, the methyl, ethyl, propyl, and butyl esters of fatty acids having from 12 to 22 carbon atoms, for example of lauric acid, myristic acid, palmitic acid, palmitolic acid, stearic acid, oleic acid, elaidic acid, petroselic acid, ricinolic acid, elaeostearic acid, linolic acid, linolenic acid, eicosanoic acid, gadoleinic acid, docosanoic acid or erucic acid. In one embodiment, alkyl fatty acid esters are the methyl esters of oleic acid, linoleic acid, linolenic acid and erucic acid.

The alkyl fatty acid ester of the present invention are obtained, for example, by hydrolyzing and esterifying animal and vegetable fats and oils by transesterifying them with relatively low aliphatic alcohols. To prepare the low alkyl esters of fatty acids, it is advantageous to start from fats and oils having a high iodine number, for example sunflower oil, rapeseed oil, coriander oil, castor oil, soya oil, cottonseed oil, peanut oil.

In one embodiment, the C1-4 alkyl fatty acid ester in the fuel composition may be present in an amount at 100 percent.

In another embodiment, the C1-4 alkyl fatty acid ester in the fuel composition may be present in an amount from about 100 percent to about 0.5 percent. In another embodiment, the C1-4 alkyl fatty acid ester in the fuel composition may be present in an amount from about 99 percent to about 0.5 percent. In another embodiment, the C1-4 alkyl fatty acid ester in the fuel composition may be present in an amount from about 50 percent to about 1.0 percent or from about 20 percent to about 5 percent.

### Nitrogen Containing Detergent

The nitrogen containing detergent of the present invention is selected from the group consisting of hydrocarbyl substituted acylated nitrogen compound; hydrocarbyl substituted amine; the reaction product of a hydrocarbyl substituted phenol, amine and formaldehyde; and mixtures thereof.

The nitrogen containing detergent of the present invention can be a hydrocarbyl substituted acylated nitrogen compound. In one embodiment, at least one nitrogen of the acylated nitrogen compound is a quaternary ammonium nitrogen. In one embodiment, the hydrocarbyl substituted acylated nitrogen compound is the reaction product of polyisobutylene succinic anhydride and polyamine, wherein the polyamine has at least one reactive hydrogen. These type nitrogen containing detergents are often referred to as a succinimide detergent. Succinimide detergents are the reaction product of a hydrocarbyl substituted succinic acylating agent and an amine containing at least one hydrogen attached to a nitrogen atom. The term “succinic acylating agent” refers to a hydrocarbon-substituted succinic acid or succinic acid-producing compound (which term also encompasses the acid itself). Such materials typically include hydrocarbyl-substituted succinic acids, anhydrides, esters (including half esters) and halides.

Succinic based detergents have a wide variety of chemical structures including typically structures such as

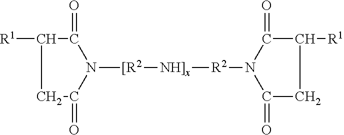

In the above structure, each R¹ is independently a hydrocarbyl group, which may be bound to multiple succinimide groups, typically a polyolefin-derived group having an M̅ₙ of 500 or 700 to 10,000. Typically the hydrocarbyl group is an alkyl group, frequently a polyisobutylene group with a molecular weight of 500 or 700 to 5000, or 1500 or 2000 to 5000. Alternatively expressed, the R¹ groups can contain 40 to 500 carbon atoms or at least 50 to 300 carbon atoms, e.g., aliphatic carbon atoms. The R² are alkylene groups, commonly ethylene (C₂H₄) groups. Such molecules are commonly derived from reaction of an alkenyl acylating agent with a polyamine, and a wide variety of linkages between the two moieties is possible beside the simple imide structure shown above, including a variety of amides structures. Succinimide detergents are more fully described in U.S. Pat. Nos. 4,234,435, 3,172,892, and 6,165,235.

The polyalkenes from which the substituent groups are derived are typically homopolymers and interpolymers of polymerizable olefin monomers of 2 to 16 carbon atoms; usually 2 to 6 carbon atoms.

The olefin monomers from which the polyalkenes are derived are polymerizable olefin monomers characterized by the presence of one or more ethylenically unsaturated groups (i.e., >C═C<); that is, they are mono-olefinic monomers such as ethylene, propylene, 1-butene, isobutene, and 1-octene or polyolefinic monomers (usually diolefinic monomers) such as 1,3-butadiene, and isoprene. These olefin monomers are usually polymerizable terminal olefins; that is, olefins characterized by the presence in their structure of the group >C═CH₂. Relatively small amounts of non-hydrocarbon substituents can be included in the polyolefin, provided that such substituents do not substantially interfere with formation of the substituted succinic acid acylating agents.

Each R¹ group may contain one or more reactive groups, e.g., succinic groups, thus being represented (prior to reaction with the amine) by structures such as

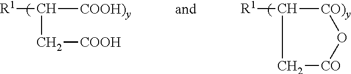

in which y represents the number of such succinic groups attached to the R¹ group. In one type of detergent, y=1. In another type of detergent, y is greater than 1, in one embodiment greater than 1.3 or greater than 1.4; and in another embodiment y is equal to or greater than 1.5. in one embodiment y is 1.4 to 3.5, such as 1.5 to 3.5 or 1.5 to 2.5. Fractional values of y, of course, can arise because different specific R¹ chains may be reacted with different numbers of succinic groups.

The amines which are reacted with the succinic acylating agents to form the carboxylic detergent composition can be monoamines or polyamines. In either case they will be characterized by the formula R⁴R⁵NH wherein R⁴ and R⁵ are each independently hydrogen, hydrocarbon, amino-substituted hydrocarbon, hydroxy-substituted hydrocarbon, alkoxy-substituted hydrocarbon, amino, carbamyl, thiocarbamyl, guanyl, or acylimidoyl groups provided that no more than one of R⁴ and R⁵ is hydrogen. In all cases, therefore, they will be characterized by the presence within their structure of at least one H—N<group. Therefore, they have at least one primary (i.e., H₂N—) or secondary amino (i.e., H—N<) group (i.e. reactive hydrogen). Examples of monoamines include ethylamine, diethylamine, n-butylamine, di-n-butylamine, allylamine, isobutylamine, cocoamine, stearylamine, laurylamine, methyllaurylamine, oleylamine, N-methyl-octylamine, dodecylamine, and octadecylamine.

The polyamines from which the detergent is derived include principally alkylene amines conforming, for the most part, to the formula

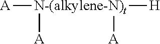

wherein t is an integer typically less than 10, A is hydrogen or a hydrocarbyl group typically having up to 30 carbon atoms, and the alkylene group is typically an alkylene group having less than 8 carbon atoms. The alkylene amines include principally, ethylene amines, hexylene amines, heptylene amines, octylene amines, other polymethylene amines. They are exemplified specifically by: ethylene diamine, diethylene triamine, triethylene tetramine, propylene diamine, decamethylene diamine, octamethylene diamine, di(heptamethylene)triamine, tripropylene tetramine, tetraethylene pentamine, trimethylene diamine, pentaethylene hexamine, di(-trimethylene)triamine. Higher homologues such as are obtained by condensing two or more of the above-illustrated alkylene amines likewise are useful. Tetraethylene pentamine is particularly useful.

The ethylene amines, also referred to as polyethylene polyamines, are especially useful. They are described in some detail under the heading “Ethylene Amines” in Encyclopedia of Chemical Technology, Kirk and Othmer, Vol. 5, pp. 898-905, Interscience Publishers, New York (1950).

Hydroxyalkyl-substituted alkylene amines, i.e., alkylene amines having one or more hydroxyalkyl substituents on the nitrogen atoms, likewise are useful. Examples of such amines include N-(2-hydroxyethyl)ethylene diamine, N,N′-bis(2-hydroxyethyl)-ethylene diamine, 1-(2-hydroxyethyl)piperazine, monohydroxypropyl)-piperazine, di-hydroxypropy-substituted tetraethylene pentamine, N-(3-hydroxypropyl)-tetra-methylene diamine, and 2-heptadecyl-1-(2-hydroxyethyl)-imidazoline.

Higher homologues, such as are obtained by condensation of the above-illustrated alkylene amines or hydroxy alkyl-substituted alkylene amines through amino radicals or through hydroxy radicals, are likewise useful. Condensed polyamines are formed by a condensation reaction between at least one hydroxy compound with at least one polyamine reactant containing at least one primary or secondary amino group and are described in U.S. Pat. No. 5,230,714 (Steckel).

The succinimide detergent is referred to as such since it normally contains nitrogen largely in the form of imide functionality, although it may be in the form of amine salts, amides, imidazolines as well as mixtures thereof. To prepare the succinimide detergent, one or more of the succinic acid-producing compounds and one or more of the amines are heated, typically with removal of water, optionally in the presence of a normally liquid, substantially inert organic liquid solvent/diluent at an elevated temperature, generally in the range of 80° C. up to the decomposition point of the mixture or the product; typically 100° C. to 300° C.

The succinic acylating agent and the amine (or organic hydroxy compound, or mixture thereof) are typically reacted in amounts sufficient to provide at least one-half equivalent, per equivalent of acid-producing compound, of the amine (or hydroxy compound, as the case may be). Generally, the maximum amount of amine present will be about 2 moles of amine per equivalent of succinic acylating agent. For the purposes of this invention, an equivalent of the amine is that amount of the amine corresponding to the total weight of amine divided by the total number of nitrogen atoms present. The number of equivalents of succinic acid-producing compound will vary with the number of succinic groups present therein, and generally, there are two equivalents of acylating reagent for each succinic group in the acylating reagents. Additional details and examples of the procedures for preparing the succinimide detergents of the present invention are included in, for example, U.S. Pat. Nos. 3,172,892; 3,219,666; 3,272,746; 4,234,435; 6,440,905 and 6,165,235.

In one embodiment, at least one of the amino groups of the succinimide detergent is further alkylated to a quaternary ammonium salt.

The nitrogen containing detergent of the present invention can be a hydrocarbyl substituted amine, which can be polyisobutylene amine. The amine used to make the polyisobutylene amine can be a polyamine such as ethylenediamine, 2-(2-aminoethylamino)ethanol, or diethylenetriamine. The polyisobutylene amine of the present invention can be prepared by several known methods generally involving amination of a derivative of a polyolefin to include a chlorinated polyolefin, a hydroformylated polyolefin, and an epoxidized polyolefin. In one embodiment of the invention the polyisobutylene amine is prepared by chlorinating a polyolefin such as a polyisobutylene and then reacting the chlorinated polyolefin with an amine such as a polyamine at elevated temperatures of generally 100 to 150° C. as described in U.S. Pat. No. 5,407,453. To improve processing a solvent can be employed, an excess of the amine can be used to minimize cross-linking, and an inorganic base such as sodium carbonate can be used to aid in removal of hydrogen chloride generated by the reaction.

In one embodiment, at least one of the amino groups of the polyisobutylene amine detergent is further alkylated to a quaternary ammonium salt.

The nitrogen containing detergent of the present invention can be the reaction product of a hydrocarbyl substituted phenol, amine and formaldehyde, which is often referred to as a Mannich detergent. Mannich detergent is a reaction product of a hydrocarbyl-substituted phenol, an aldehyde, and an amine or ammonia. The hydrocarbyl substituent of the hydrocarbyl-substituted phenol can have 10 to 400 carbon atoms, in another instance 30 to 180 carbon atoms, and in a further instance 10 or 40 to 110 carbon atoms. This hydrocarbyl substituent can be derived from an olefin or a polyolefin. Useful olefins include alpha-olefins, such as 1-decene, which are commercially available.

The polyolefins which can form the hydrocarbyl substituent can be prepared by polymerizing olefin monomers by well known polymerization methods and are also commercially available. The olefin monomers include monoolefins, including monoolefins having 2 to 10 carbon atoms such as ethylene, propylene, 1-butene, isobutylene, and 1-decene. An especially useful monoolefin source is a C₄ refinery stream having a 35 to 75 weight percent butene content and a 30 to 60 weight percent isobutene content. Useful olefin monomers also include diolefins such as isoprene and 1,3-butadiene. Olefin monomers can also include mixtures of two or more monoolefins, of two or more diolefins, or of one or more monoolefins and one or more diolefins. Useful polyolefins include polyisobutylenes having a number average molecular weight of 140 to 5000, in another instance of 400 to 2500, and in a further instance of 140 or 500 to 1500. The polyisobutylene can have a vinylidene double bond content of 5 to 69 percent, in a second instance of 50 to 69 percent, and in a third instance of 50 to 95 percent. The polyolefin can be a homopolymer prepared from a single olefin monomer or a copolymer prepared from a mixture of two or more olefin monomers. Also possible as the hydrocarbyl substituent source are mixtures of two or more homopolymers, two or more copolymers, or one or more homopolymers and one or more copolymers.

The hydrocarbyl-substituted phenol can be prepared by alkylating phenol with an olefin or polyolefin described above, such as a polyisobutylene or polypropylene, using well-known alkylation methods.

The aldehyde used to form the Mannich detergent can have 1 to 10 carbon atoms, and is generally formaldehyde or a reactive equivalent thereof such as formalin or paraformaldehyde.

The amine used to form the Mannich detergent can be a monoamine or a polyamine, including alkanolamines having one or more hydroxyl groups, as described in greater detail above. Useful amines include those described above, such as ethanolamine, diethanolamine, methylamine, dimethylamine, ethylenediamine, dimethylaminopropylamine, diethylenetriamine and 2-(2-aminoethylamino)ethanol. The Mannich detergent can be prepared by reacting a hydrocarbyl-substituted phenol, an aldehyde, and an amine as described in U.S. Pat. No. 5,697,988. In one embodiment of this invention the Mannich reaction product is prepared from an alkylphenol derived from a polyisobutylene, formaldehyde, and an amine that is a primary monoamine, a secondary monoamine, or an alkylenediamine, in particular, ethylenediamine or dimethylamine.

The Mannich reaction product of the present invention can be prepared by reacting the alkyl-substituted hydroxyaromatic compound, aldehyde and polyamine by well known methods including the method described in U.S. Pat. No. 5,876,468.

The Mannich reaction product can be prepared by well known methods generally involving reacting the hydrocarbyl substituted hydroxy aromatic compound, an aldehyde and an amine at temperatures between 50 to 200° C. in the presence of a solvent or diluent while removing reaction water as described in U.S. Pat. No. 5,876,468.

Yet another type of nitrogen containing detergent, which can be used in the present invention, is a glyoxylate. A glyoxylate detergent is a fuel soluble ashless detergent which, in a first embodiment, is the reaction product of an amine having at least one basic nitrogen, i.e. one >N—H, and a hydrocarbyl substituted acylating agent resulting from the reaction, of a long chain hydrocarbon containing an olefinic bond with at least one carboxylic reactant selected from the group consisting of compounds of the formula (I)

(R¹C(O)(R²)ₙC(O))R³ (I)

and compounds of the formula (II)

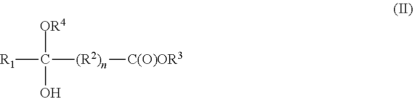

wherein each of R¹, R³ and R⁴ is independently H or a hydrocarbyl group, R² is a divalent hydrocarbylene group having 1 to 3 carbons and n is 0 or 1:

Examples of carboxylic reactants are glyoxylic acid, glyoxylic acid methyl ester methyl hemiacetal, and other omega-oxoalkanoic acids, keto alkanoic acids such as pyruvic acid, levulinic acid, ketovaleric acids, ketobutyric acids and numerous others. The skilled worker having the disclosure before him will readily recognize the appropriate compound of formula (I) to employ as a reactant to generate a given intermediate.

The hydrocarbyl substituted acylating agent can be the reaction of a long chain hydrocarbon containing an olefin and the above described carboxylic reactant of formula (I) and (II), further carried out in the presence of at least one aldehyde or ketone. Typically, the aldehyde or ketone contains from 1 to about 12 carbon atoms. Suitable aldehydes include formaldehyde, acetaldehyde, propionaldehyde, butyraldehyde, isobutyraldehyde, pentanal, hexanal. heptaldehyde, octanal, benzaldehyde, and higher aldehydes. Other aldehydes, such as dialdehydes, especially glyoxal, are useful, although monoaldehydes are generally preferred. Suitable ketones include acetone, butanone, methyl ethyl ketone, and other ketones. Typically, one of the hydrocarbyl groups of the ketone is methyl. Mixtures of two or more aldehydes and/or ketones are also useful.

Compounds and the processes for making these compounds are disclosed in U.S. Pat. Nos. 5,696,060; 5,696,067; 5,739,356; 5,777,142; 5,856,524; 5,786,490; 6,020,500; 6,114,547; 5,840,920 and are incorporated herein by reference.

In one embodiment, at least one of the amino groups of the Mannich detergent is further alkylated to a quaternary ammonium salt.

In another embodiment, the nitrogen containing detergent can be a glyoxylate. The glyoxylate detergent is the reaction product of an amine having at least one basic nitrogen, i.e. one >N—H, and a hydrocarbyl substituted acylating agent resulting from the condensation product of a hydroxyaromatic compound and at least one carboxylic reactant selected from the group consisting of the above described compounds of the formula (I) and compounds of the formula (II). Examples of carboxylic reactants are glyoxylic acid, glyoxylic acid methyl ester methyl hemiacetal, and other such materials as listed above.

The hydroxyaromatic compounds typically contain directly at least one hydrocarbyl group R bonded to at least one aromatic group. The hydrocarbyl group R may contain up to about 750 carbon atoms or 4 to 750 carbon atoms, or 4 to 400 carbon atoms or 4 to 100 carbon atoms. In one embodiment, at least one R is derived from polybutene. In another embodiment, R is derived from polypropylene.

In another embodiment, the reaction of the hydroxyaromatic compound and the above described carboxylic acid reactant of formula (I) or (II) can be carried out in the presence of at least one aldehyde or ketone. The aldehyde or ketone reactant employed in this embodiment is a carbonyl compound other than a carboxy-substituted carbonyl compound. Suitable aldehydes include monoaldehydes such as formaldehyde, acetaldehyde, propionaldehyde, butyraldehyde, isobutyraldehyde, pentanal, hexanal, heptaldehyde, octanal, benzaldehyde, and higher aldehydes. Other aldehydes, such as dialdehydes, especially glyoxal, are useful. Suitable ketones include acetone, butanone, methyl ethyl ketone, and other ketones. Typically, one of the hydrocarbyl groups of the ketone is methyl. Mixtures of two or more aldehydes and/or ketones are also useful.

In one embodiment, at least one of the amino groups of the glyoxylate detergent is further alkylated to a quaternary ammonium salt.

Compounds and the processes for making these compounds are disclosed in U.S. Pat. Nos. 3,954,808; 5,336,278; 5,620,949 and 5,458,793 and are incorporated herein by reference

The detergent additive of this invention can be present in a mixture of various detergents referenced above.

In one embodiment, the nitrogen containing detergent in the fuel composition may be present in an amount from about 1 to about 1000 ppm, or about 5 to about 500, or about 20 to about 500 or about 50 to about 500 ppm.

In another embodiment, the nitrogen containing detergent in the fuel composition further containing a fuel which is liquid at room temperature other than C₁₋₄ alkyl fatty acid ester may be present in an amount from about 1 to about 1000 ppm, or about 5 to about 500 ppm, or about 10 to about 300 ppm, or about 10 to about 200 ppm or about 10 to about 100 ppm.

### Phenolic Antioxidant

The fuel composition of the present invention can comprise a phenolic antioxidant. The phenolic antioxidant is an alkylated phenol. Alkylated phenol of the present invention can be of the type represented by the formula

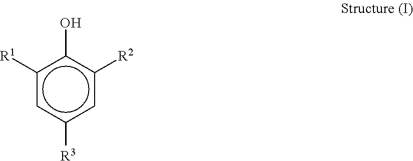

where R¹, R² and R³ are independently H; hydrocarbyl groups; groups of the structure:

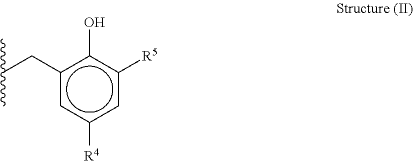

where R⁴ and R⁵ are independently H, or hydrocarbyl groups; or
wherein any of R¹, R², R³, R⁴, or R⁵ can independently be

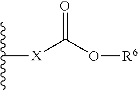

where X is C₁₋₄ a alkylene and R⁶ is C₁₋₁₆ hydrocarbyl group. In another embodiment R6 can be a C₁₋₈, C₄₋₈, or C₆₋₈ hydrocarbyl group.

In another embodiment, the alkylated phenol of the present invention can be of the structure (I) where R¹, R² and R³ are independently H or hydrocarbyl groups. In yet another embodiment, R¹, R² and R³ are independently H or C₁₋₁₂ alkyl groups. In another embodiment, R¹, and R² are C₄ alkyl groups. In another embodiment, R³ is H. An example of such alkylated phenol is 2,6,-di-t-butylphenol. The preparation of these above mentioned antioxidants can be found in U.S. Pat. Nos. 6,559,105, and 6,787,663

In one embodiment, the phenolic antioxidant in the fuel composition may be present in an amount from about 1 to about 10000 ppm, or about 50 to about 5000, or about 100 to about 5000 or about 350 to about 5000 ppm or about 500 to about 5000 ppm.

In another embodiment, the phenolic antioxidant in the fuel composition further containing a fuel which is liquid at room temperature other than C₁₋₄ alkyl fatty acid ester may be present in an amount from about 1 to about 1000 ppm, or about 5 to about 500 ppm, or about 10 to about 300 ppm, or about 10 to about 200 ppm or about 10 to about 100 ppm.

### Fuel

The fuel composition of the present invention can further comprise a fuel which is a liquid at room temperature other than the C₁₋₄ alkyl fatty acid ester. The fuel is normally a liquid at ambient conditions e.g., room temperature (20 to 30° C.). The fuel can be a hydrocarbon fuel The hydrocarbon fuel can be a petroleum distillate to include a diesel fuel as defined by ASTM specification D975. In one embodiment of this invention, the fuel is a diesel fuel. The hydrocarbon fuel can be a hydrocarbon prepared by a gas to liquid process to include, for example, hydrocarbons prepared by a process, such as, the Fischer-Tropsch process. In several embodiments of this invention, the fuel can have a sulfur content on a weight basis that is 5000 ppm or less, 1000 ppm or less, 300 ppm or less, 200 ppm or less, 30 ppm or less, or ppm or less. In another embodiment, the fuel can have a sulfur content on a weight basis of 1 to 100 ppm. In one embodiment, the fuel contains 0 ppm to 1000 ppm, or 0 to 500 ppm, or 0 to 100 ppm, or 0 to 50 ppm, or 0 to 25 ppm, or 0 to 10 ppm, or 0 to 5 ppm of alkali metals, alkaline earth metals, transition metals or mixtures thereof. In another embodiment, the fuel contains 1 to 10 ppm by weight of alkali metals, alkaline earth metals, transition metals or mixtures thereof. It is well known in the art that a fuel containing alkali metals, alkaline earth metals, transition metals or mixtures thereof have a greater tendency to form deposits and therefore foul or plug injectors. The fuel which is a liquid at room temperature other than the C₁₋₄ alkyl fatty acid ester can be present in a fuel composition in one embodiment an amount from about 99 percent to about 0.1 percent or from about 50 percent to about 1 percent. In another embodiment, the fuel which is a liquid at room temperature other than the C₁₋₄ alkyl fatty acid ester can be present in a fuel composition from about 40 percent to about 5 percent or from about 30 percent to about 5 percent, or from about 20 percent to about 5 percent.

### INDUSTRIAL APPLICATION

In one embodiment the invention is useful for a liquid fuel or for an internal combustion engine. The internal combustion engine includes compression ignited engines fuelled with diesel fuel. The diesel engine includes both light duty and heavy duty diesel engines.

### Miscellaneous

As used herein, the term “hydrocarbyl substituent” or “hydrocarbyl group” is used in its ordinary sense, which is well-known to those skilled in the art. Specifically, it refers to a group having a carbon atom directly attached to the remainder of the molecule and having predominantly hydrocarbon character. Examples of hydrocarbyl groups include: hydrocarbon substituents, that is, aliphatic (e.g., alkyl or alkenyl), alicyclic (e.g., cycloalkyl, cycloalkenyl) substituents, and aromatic-, aliphatic-, and alicyclic-substituted aromatic substituents, as well as cyclic substituents wherein the ring is completed through another portion of the molecule (e.g., two substituents together form a ring); substituted hydrocarbon substituents, that is, substituents containing non-hydrocarbon groups which, in the context of this invention, do not alter the predominantly hydrocarbon nature of the substituent (e.g., halo (especially chloro and fluoro), hydroxy, alkoxy, mercapto, alkylmercapto, nitro, nitroso, and sulfoxy); hetero substituents, that is, substituents which, while having a predominantly hydrocarbon character, in the context of this invention, contain other than carbon in a ring or chain otherwise composed of carbon atoms. Heteroatoms include sulfur, oxygen, nitrogen, and encompass substituents as pyridyl, furyl, thienyl and imidazolyl. In general, no more than two, preferably no more than one, non-hydrocarbon substituent will be present for every ten carbon atoms in the hydrocarbyl group; typically, there will be no non-hydrocarbon substituents in the hydrocarbyl group.

It is known that some of the materials described above may interact in the final formulation, so that the components of the final formulation may be different from those that are initially added. For instance, metal ions (of, e.g., a detergent) can migrate to other acidic or anionic sites of other molecules. The products formed thereby, including the products formed upon employing the composition of the present invention in its intended use, may not be susceptible of easy description. Nevertheless, all such modifications and reaction products are included within the scope of the present invention; the present invention encompasses the composition prepared by admixing the components described above.

### EXAMPLES

The invention will be further illustrated by the following examples, which sets forth particularly advantageous embodiments. While the examples are provided to illustrate the present invention, they are not intended to limit it.

The fuel compositions found in Table 1 below are evaluated in the Rancimat Oxidation Test as defined by the EN 14112:2003 for determination of oxidation stability.

TABLE 1
Rancimat Oxidation Test
Fuel Composition

| Compo- | Base- | Exam- | Exam- | Exam- | Exam- | Exam- | Exam- |
|---|---|---|---|---|---|---|---|
| nents | line | ple 1 | ple 2 | ple 3 | ple 4 | ple 5 | ple 6 |
| AOX¹ | — | 300 | 200.25 | 200 | 100 | 297.25 | — |
| (ppm) | | | | | | | |
| AOX² | — | — | — | — | — | — | 300 |
| (ppm) | | | | | | | |
| Deter- | — | 100 | 24.75 | 100 | 25 | 65.25 | 100 |
| gent³ | | | | | | | |
| (ppm) | | | | | | | |
| Test | | | | | | | |
| Results | | | | | | | |
| Hours | 4.59 | 12.9 | 8.34 | 8.79 | 7.89 | 10.7 | 5.94 |

Note:
All the fuel compositions of Table 1 are evaluated in rape seed methyl ester biodiesel fuel (RME).
Note:
¹the AOX is 2,6-di-tert-butylphenol antioxidant.
Note:
²the AOX is nonylated diphenylamine.
Note:
³the detergent is polyisobutylene succinimide which contains 13.5% by weight diluent mineral oil.

The results of the test reveal that a biodiesel fuel utilizing the combination of antioxidant and detergent of the present invention (see Examples 1-5) shows greater oxidative stability compared to the baseline. Additionally, the tests reveal that a biodiesel fuel utilizing the combination of antioxidant and detergent of the present invention (see Examples 1-5) shows greater oxidative stability compared to Example 6, which contains a different type of antioxidant.

The fuel compositions of the present invention are further evaluated in the ASTM D2274F oxidative stability test. This test method measures the amount of insoluble oxidized materials present as mg/100 ml.

TABLE 2
ASTM D 2274F
Fuel Composition

| Components | Example 7 | Example 8 | Example 9 | Example 10 |
|---|---|---|---|---|
| SME¹ | 10 wt % | — | 10 wt % | — |
| (SME/AOX)² | — | 10 wt % | — | 10 wt % |
| ULSD³ | 90 wt % | 90 wt % | 90 wt % | 90 wt % |
| Detergent⁴ | — | — | 35 ppm | 35 ppm |
| Test Results | | | | |
| Total insoluble | 439.96 | 5.05 | 556.37 | 1.00 |
| mg/100 ml | | | | |

Note:
¹SME is soya methyl ester.
Note:
²SME/AOX is mixture of soya methyl ester and 500 ppm of 2,6-di-tert-butylphenol antioxidant.
Note:
³ULSD is ultra low sulfur diesel fuel.
Note:
⁴the detergent is polyisobutylene succinimide which contain 13.5% by weight diluent mineral oil.

The results of the test reveal that a biodiesel blended fuel utilizing the combination of antioxidant and detergent of the present invention shows greater oxidative stability compared to biodiesel blended fuels without any detergents or antioxidants present in the fuel composition. Additionally, the results reveal that a biodiesel blended fuel utilizing the combination of antioxidant and detergent of the present invention shows greater oxidative stability compared to biodiesel blended fuels with an antioxidant but without any detergents in the fuel composition.

Each of the documents referred to above is incorporated herein by reference. Except in the Examples, or where otherwise explicitly indicated, all numerical quantities in this description specifying amounts of materials, reaction conditions, molecular weights, number of carbon atoms, and the like, are to be understood as modified by the word “about.” Unless otherwise indicated, each chemical or composition referred to herein should be interpreted as being a commercial grade material which may contain the isomers, by-products, derivatives, and other such materials which are normally understood to be present in the commercial grade. However, the amount of each chemical component is presented exclusive of any solvent or diluent oil, which may be customarily present in the commercial material, unless otherwise indicated. It is to be understood that the upper and lower amount, range, and ratio limits set forth herein may be independently combined. Similarly, the ranges and amounts for each element of the invention can be used together with ranges or amounts for any of the other elements. As used herein, the expression “consisting essentially of” permits the inclusion of substances that do not materially affect the basic and novel characteristics of the composition under consideration.

What we claim:

1. A fuel composition, comprising:
a. C₁₋₄ alkyl fatty acid ester;
b. a nitrogen containing detergent; and
c. a phenolic antioxidant.

2. The fuel composition of claim 1, wherein the nitrogen containing detergent is selected from the group consisting of hydrocarbyl substituted acylated nitrogen compound; hydrocarbyl substituted amine; the reaction product of a hydrocarbyl substituted phenol, amine and formaldehyde; and mixtures thereof.

3. The fuel composition of claim 2, wherein the hydrocarbyl substituted acylated nitrogen compound is the reaction product of polyisobutylene succinic anhydride and polyamine.

4. The fuel composition of claim 3, wherein the polyamine has at least one reactive hydrogen.

5. The fuel composition of claim 1, wherein the phenolic antioxidant is an alkylated phenol.

6. The fuel composition of claim 5, wherein the alkylated phenol is represented by the structure: 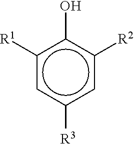
wherein R¹, R² and R³ are independently H or hydrocarbyl groups.

7. The fuel composition of claim 6, wherein R¹, R², and R³ are independently H or C₁₋₁₂ alkyl groups.

8. The fuel composition of claim 7, wherein R¹ and R² is a C₄ alkyl group.

9. The fuel composition of claim 7, wherein R³ is H.

10. The fuel composition of claim 1, further comprising (d) a fuel which is a liquid at room temperature other than (a).

11. A method of fuel an internal combustion engine, comprising:
A. supplying to the internal combustion engine
i. C₁₋₄ alkyl fatty acid ester;
ii. a fuel which is a liquid at room temperature other than (i);
iii. a nitrogen containing detergent; and
iv. a phenolic antioxidant.
